(19) United States
(12) Patent Application Publication
(10) Pub. No.: US 2005/0149974 A1
(43) Pub. Date: Jul. 7, 2005

(54) Interactive reverse channel for direct broadcast satellite system

(75) Inventor: Frank B. Norman, New Westminster (CA)

Correspondence Address: TORYS LLP, 79 WELLINGTON ST. WEST, SUITE 3000, TORONTO, ON, M5K 1N2, CA

(73) Assignee: STENTOR RESOURCE CENTRE INC., Ottawa (CA)

(21) Appl. No.: 10/997,906

(22) Filed: Nov. 29, 2004

Related U.S. Application Data
(63) Continuation of application No. 09/311,611, filed on May 13, 1999.
Application No. 09/311,611 is a division of application No. 08/668,816, filed on Jun. 24, 1996, now abandoned.

(51) Int. Cl. G06F 3/00; H04N 5/445; G06F 13/00; H04N 7/20; H04N 7/173; H04N 7/16

(52) U.S. Cl. 725/73; 725/148; 725/114

(57) ABSTRACT

A system and method is disclosed for providing a reverse channel to enable interactive communication between a DBS subscriber and DBS service provider. The addition of an interactive return channel overcomes the problems associated with existing audience measurement systems as well as the problems associated with existing DBS signal security techniques.

### FIELD OF THE INVENTION

This invention relates to direct broadcast satellite systems but more particularly to the provision of an interactive reverse channel for enabling communication between a direct broadcast satellite server and DBS subscribers.

### BACKGROUND OF THE INVENTION

Direct broadcast satellite (DBS) systems were designed to provide distribution of multiple television signals (channels) to service subscribers within the footprint of the DBS satellite antenna. The intention of DBS systems is to compete with cable television systems. Unfortunately, DBS systems are one way high bandwidth delivery systems. They are not designed to have a return path via the satellite to the DBS service provider, although such a return channel is very desirable. The unavailability of a return channel between DBS service subscribers and DBS service providers have resulted in two shortcomings of DBS systems. One is that DBS providers have a major problem in providing feedback of audience watching habits. Second, DBS systems are prone to signal security breaches and thus suffer from piracy of the signals.

In the first instance, because of the difficulty in proving audiences of sufficient quantity and quality, DBS system providers have had difficulty in trying to gain the interest of major advertisers.

Existing audience measurement systems are based on a limited metering and monitoring of a small sample of customers, using facilities other than the equipment which comprises the DBS system. Such systems are often affected by the knowledge by the sample group that they are being monitored. They are also relatively expensive to implement.

Audience measurement is an essential part of modern television and is the cornerstone of the business. Television programs are scheduled and cancelled, and advertising time is bought and sold based on audience measurement.

The field of television audience measurement is dominated today by one company—Neilsen. This company has dominated the field for so long and so completely many of its customers believe they have lost sight of their needs and it no longer provides timely and effective responses to the evolving requirements of this crucial field. The Neilsen ratings were developed to meet the needs of the broadcast industry, but today many other sectors of the television industry need ratings service and these other fields (cable and DBS) feel particularly strongly that their needs are not met by conventional methods as they regard the ratings companies as being beholden to broadcasters.

Early in 1995, the only major competitor to Neilsen, Arbitron, abandoned the television ratings business and exacerbated the problem of a monopolistic attitude to customer requirements. Not only are cable and DBS operators dissatisfied, but so are Neilsen's prime customers—the broadcast networks. The broadcast networks are so dissatisfied that they have initiated developing their own state-of-the-art ratings laboratory, and have contracted with Statistical Research Inc. (SRI) to implement the new lab, and SRI has already developed new metering devices and program coding devices.

The existing ratings technologies are based on sampling of the audience coupled with a variety of techniques for measuring watching and attentiveness within the sampled residences. Reporting of the gathered data is performed monthly by telephone from each residence and data is uploaded for analysis. There is no form of immediate or interactive activity between an advertiser and the television audience. This final point has become very significant as the Internet has blossomed, and businesses who use the Internet can see that in that environment they can get immediate response and interactivity. Hence they know quickly if the money that they are spending on Internet advertising is cost-effective. As a result of this exposure to immediate and interactive advertising, the frustration with the limitations of conventional television advertising and audience measurement has become a major concern to television advertisers.

Neilsen typically samples abut 4000 residences for its television ratings. These sampled residences have over the years been provided with a variety of boxes (usually termed People Meters) on which the household residents were supposed to record their television viewing. It is normal practice to pay households who agree to accept a People Meter i their home.

People Meters typically involved pressing buttons as people entered or left the room containing the television. The use of such active methods is sporadic, and response of children and visitors is particularly bad. More recent Neilsen efforts to monitor the residents of a household has focused on trying to perfect a passive system based on image recognition. This system tries to match camera images of any moving object with stored images of the household members. The first attempts were very unsuccessful due to problems such as low room lighting. This problem is being overcome by flooding the room with invisible light for the purpose, but even so the image matching is poor. If it is ever made to work satisfactorily, its major improvement will be to replace active systems with a passive one. However, television broadcasters are already saying in effect this is too little too late—they want real time interactive systems. In addition, major privacy concerns have surfaced with this new and invasive technique.

As indicated previously, the other shortcoming to DBS systems is with regards to signal security.

Satellite television systems to date have suffered major problems due to piracy of the signals. These problems have been well documented in the media.

At present DBS security systems are based on encryption of the transmitted television signals which are decrypted in the individual clients set-top boxes. Data transmitted with the broadcast signal is used in the process of enabling set-top decryption for specific channels or events. The set-top box accepts a small card inserted by the user, records the viewing of specific events and compiles a usage record which is reported to the DBS service provider approximately once a month by means of an automatic dial-out over the POTs network, or by means of a polling call to the client set-top box by the DBS service provider.

In a typical existing DBS systems, the video signal is encrypted at the sending office with a private key. The receiver, at the subscriber premises, received this encrypted signal together with an indicator of where to look on the smart card for a means of determining the private key with which to decrypt the signal, so that viewing is possible.

The private key itself is not sent from the sending office. Only an indicator of how to determine the key, based on algorithms and random numbers already stored on the subscriber's smart card, is transmitted from the sending office over the DBS system.

The smart card serves the function of authenticating the user. This is not an interactive process—mere possession of the card is sufficient authentication. The card will only operate in the individual subscriber's set-top box. In addition, it accepts an “indicator” to the decryption key, which when combined with part of the contents of the smart card enables the smart card to determine the decryption key. Thus, the establishing of the decryption key is based on the match between the set-top box and the smart card, the receipt of the “indicator” from the sending office, and the algorithms and data contained within the smart card.

For example, the key could be based on one or more random numbers. In a simple system, the sending office would look up a random number from a previously existing table. It would use this random number as the key with which it would encrypt the video signal. It would transmit the encrypted signal, together with a pointer to the receiver. The pointer is the indicator which the receiver uses to locate the same random number from the same table used at the sending office, only in this case the table is contained within the smart card. Once it has located the random number, it can then use this random number to decrypt the video signal.

The foregoing is a very simple version of what happens, but the principles are correct. To increase security, the key is changed every few seconds, and more than one random number may be used to construct the key, plus the random numbers may not be directly, but may be subjected to an algorithm which computes the actual key to be used.

Despite the technical complexity of the foregoing techniques, and the sophisticated technology of the smart card which has been designed to prevent any breaching of its security mechanisms by reverse engineering and duplicating the smart card, existing DBS security arrangements have been compromised several times and on a massive scale.

Accordingly, a need exists for a solution which can overcome the aforementioned problems for DBS systems.

In particular, a need exists for a system and method of providing a reverse channel to enable interactive communication between a DBS subscriber and DBS service provider. The addition of an interactive return channel overcomes the problems associated with existing audience measurement systems as well as the problem associated with existing DBS signal security techniques.

Although a return channel can be provided at present, it requires the use of a leased line from a telephone company to each of the DBS subscriber stations. A lease line provides an expensive return channel and is generally impractical because of the cost. It has accordingly not been considered as a valid approach for universal use.

### SUMMARY OF THE INVENTION

It is therefore an object of the present invention to provide a low-cost return channel between DBS subscriber stations and a DBS service provider and which is capable of carrying interactive communication.

Another object of the present invention is to provide a system and method of providing a low-cost return channel which can be set up to provide a full-time interactive communication channel between a DBS subscriber station and a DOS service provider.

Yet another object of the present invention is to provide a system and method of providing an interactive communication channel between DBS subscriber stations and DBS service providers over a communication path established over the Internet network.

According to a first aspect of the present invention, there is provided a method of providing an interactive communication channel over the Internet between a provider of Direct Broadcast Services (DBS) and DBS subscribers, comprising:
connecting a DBS subscriber station to a first Internet intertace having a first Internet Protocol (IP) address;
connecting a DBS server to a second Internet interface having a second Internet Protocol address;
providing a communication path between said first Internet interface and a first Internet Service Provider (ISP) and between said DBS server and a second ISP; and
establishing a communication link between said DBS server and said DBS subscriber station via said first and second ISP over the Internet network to enable the interactive exchange and retrieval of information between said DBS provider and said DBS subscriber station.

According to another aspect of the present invention, there is provided a system for providing an interactive communication channel over the Internet between a provider of Direct Broadcast Services (DBS) and DBS subscribers, comprising:

a DBS subscriber station for receiving and decoding DBS signals;

first Internet interface means for connecting said DBS subscriber station to an Internet network, said first Internet interface means having a first Internet Protocol (IP) address;
second Internet interface means for connecting a DBS provider's server to said Internet network, said second Internet interface means having a second Internet Protocol (IP) address; and

communication link means between said first Internet interface means and said Internet network, to enable the interactive exchange and retrieval of information between said DBS server and said DBS subscriber station via said Internet network.

### BRIEF DESCRIPTION OF THE DRAWINGS

FIG. 1 is a diagram illustrating the basic concept of a prior art direct broadcast satellite system;

FIGS. 2a, 2b and 2c are illustrations of prior art means of defeating DBS security systems;

FIG. 3 is a diagram illustrating the provision of a low-cost return channel between DBS subscriber stations and a DBS server according to a first embodiment of the present invention;

FIG. 4a is a block diagram illustrating the means for providing a return channel from a DBS subscriber station to the Internet; and

FIG. 4b in a diagram illustrating the main subsystems forming part of the Internet interface of FIG. 4a.

### DESCRIPTION OF THE PREFERRED EMBODIMENTS

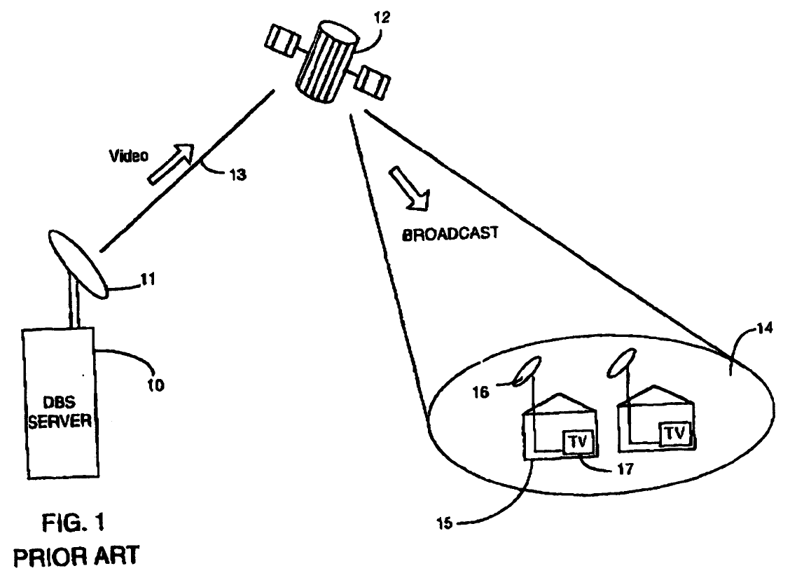

Referring now to FIG. 1, we have shown a diagram illustrating the basic concept of a prior art Direct Broadcast Satellite (DBS) system. The main components of a DBS system include a DBS server 10 located at the service provider which collects a variety of channels from various sources. These are then coded for transmission, via a satellite dish 11, to a geostationary satellite 12. The geostationary satellite 12 receives the video signal 13, amplifies it, and broadcasts the video signal over a large footprint 14. The footprint 14 is large enough to cover or to provide service to DBS subscribers located in most regions of North America. The high frequency digital broadcast signal is received at a subscriber's residence 15 by means of small-size receiver dishes. The signal is then decoded for viewing on the subscriber's television set 17. The digital signal received at the subscriber's residence 15 offers a higher signal-to-noise ratio than a similar signal received over cable. In addition, the signal carried by a DBS service provider offers a much larger selection of channels than standard cable television.

For this reason, a grey market of pirated equipment exists to enable the illegal reception and decoding of the broadcast signal.

Prior to the implementation of this invention, DBS systems provided distribution of multiple television signals in a forward direction to subscribers located within the footprint of the DBS satellite antenna. The DBS server could send short forward messages to individual subscribers in a broadcast mode, by including a message for each individual subscriber in the signal from the DBS server, that was relayed through the satellite.

These short forward messages would include frequently updated encryption keys that are used by the set-top box in the ongoing decryption process as well as program schedules. As described previously, existing DBS systems use smart cards in conjunction with the decoder contained in the set-top box to control access to the various television signals received by the DBS subscribers.

Prior to this invention, there was no method of economically providing a DBS reverse channel for interactive real-time communication between the DBS service provider and the DBS subscribers which would be available for the entire time that the DBS service was in use, and that could be available to a widespread base of subscribers.

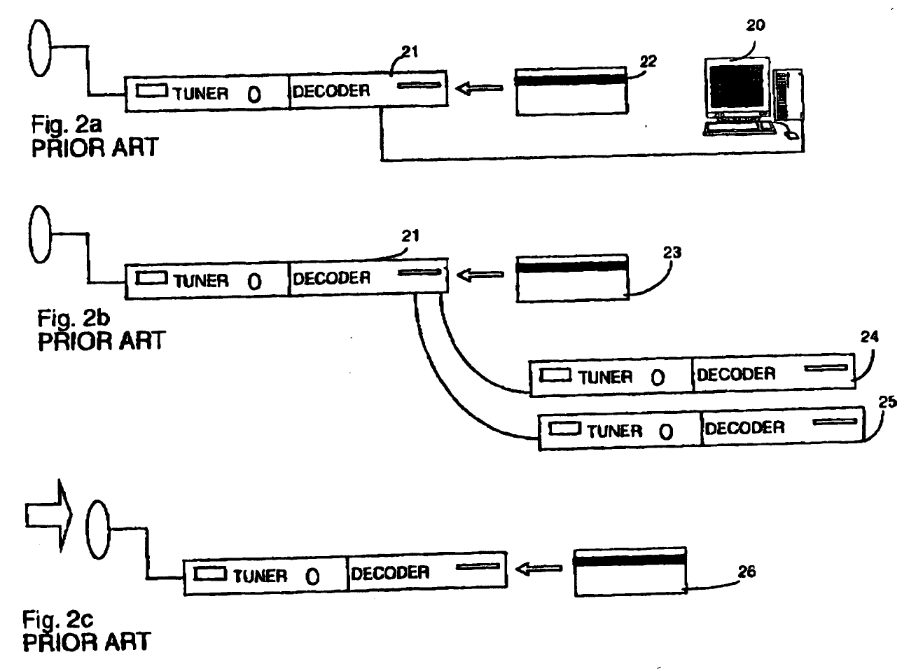

FIGS. 2a, 2b and 2c show some of the better known methods of compromising existing DBS security systems. One technique includes, as shown in FIG. 2a, PC programs to emulate the start card. A PC 20 connected to the decoder portion 21 of the DBS receiver can emulate the function of a smart card 22. In this technique, a card reader would be used to transfer data from the card to a PC. The PC could then be used in other systems where cards are not available.

In the technique of FIG. 2b, the authorization codes of the smart card 23 are used to enable the decoder 21 to feed multiple decoders 24 and 25.

Finally in the technique of FIG. 2c, the smart card 26 is validated by emulating the receipt of valid DBS authorization codes.

The problems associated with signal piracy in DBS arise from the fact that the equipment installed at the subscriber's premises is out of control of the DBS service provider. Activation and validation of codes are broadcast to all subscriber stations which therefore makes it impossible for the service provider to control who is authorized to receive new validation codes.

The existing DBS encryption method is a form of private key encryption. In a private key encryption system, the encryption keys are known by the sending and receiving equipment. Private key encryption systems are well suited for situations there both sender and receiver are “trusted”. However, as indicated previously, the problems that have been encountered are essentially due to the fact that the receiving end (i.e. the DBS subscriber residence) is not a trusted environment, and attacks for the purpose of signal piracy are launched on the receiving equipment which is host of the decryption process.

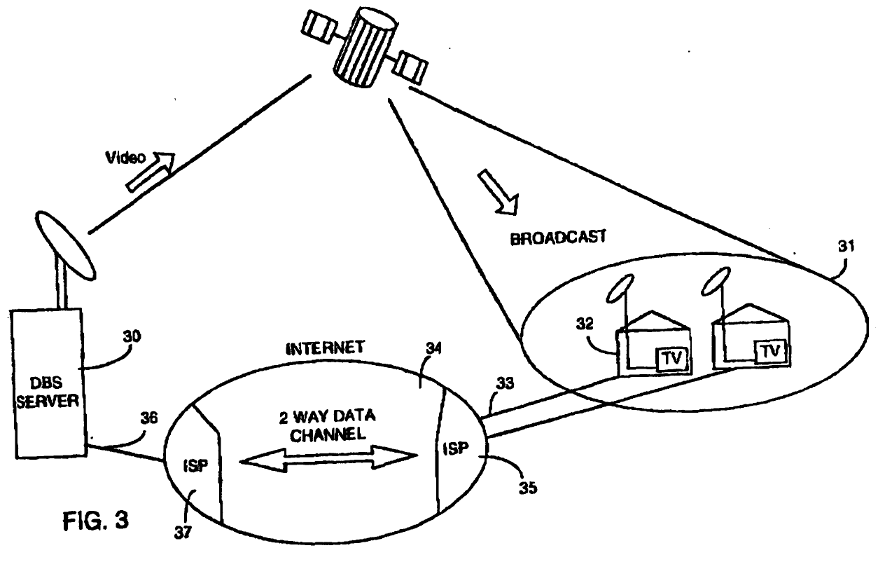

Referring now to FIG. 3, we have shown a diagram illustrating system according to the preferred embodiment of the present invention. The system and method of the present invention provide major enhancements to the service and operational capabilities of DBS systems.

This invention adds the capabilities of the Internet as an interactive communication link to those of a DBS system. In so doing, the invention overcomes a major drawback of existing DBS systems which do not have a viable method of communicating from the subscriber to the service provider continuously and in real time. By adding the Internet to the DBS system it is possible not only to add a reverse channel, but to add an interactive channel for control and real-time communication between the subscriber (set-top box) and the service provider (server).

The invention covers not only the integration of the Internet with A DBS system, but also the application of this combined Internet/DBS system to provide all new services which are enabled by the synergy between the Internet and the DBS system, and specifically, enhanced audience metering and DBS signal security.

With the system and method of the present invention, the DBS system elements remain the same as those presented in FIG. 1. However, as illustrated in FIG. 3, with the present invention, an interactive link is established between the DBS provider's server 30 and each DBS subscriber station located in the DBS signal's footprint 31. In particular, a subscriber residence 32 is provided with a return or interactive channel by means of a communication link 33 which receives and sends data via the Internet network 34 to DBS server 30. The use of the Internet network 34 enables the DBS service provider to provide a low-cost return channel from each of the subscriber's residence. The Internet network 34 can carry two-way data in relatively real time. Real time is used here to mean that the information is exchanged in response to a query or command from the DBS server 30 to the DBS subscriber station while the subscriber station is performing its intended function. Although not essential, in the preferred embodiment of the present invention, a full-time communication link 33 is provided between the subscriber residence 32 and a first Internet service provider 35. This full-time communication link can be provided by means of Asymmetrical Digital Subscriber Lines (ADSL) or Symmetrical Digital Subscribe Lines (SDSL). A high-capacity communication link 36 is set up between the DBS service provider's server 30 and a second Internet service provider 37. The DBS server 30 can communicate with individual subscriber stations by sending Internet packets to an Internet Protocol (IP) address associated with each DBS subscriber station. In this fashion, queries for audience measurement statistics can be retrieved in real time from the subscriber station, or the subscriber station can automatically send information at regular intervals, or whenever a change occurs, for example when the channel or other setting is changed. Similarly, public encryption keys can be transmitted continuously to each subscriber station to update their decoding algorithms.

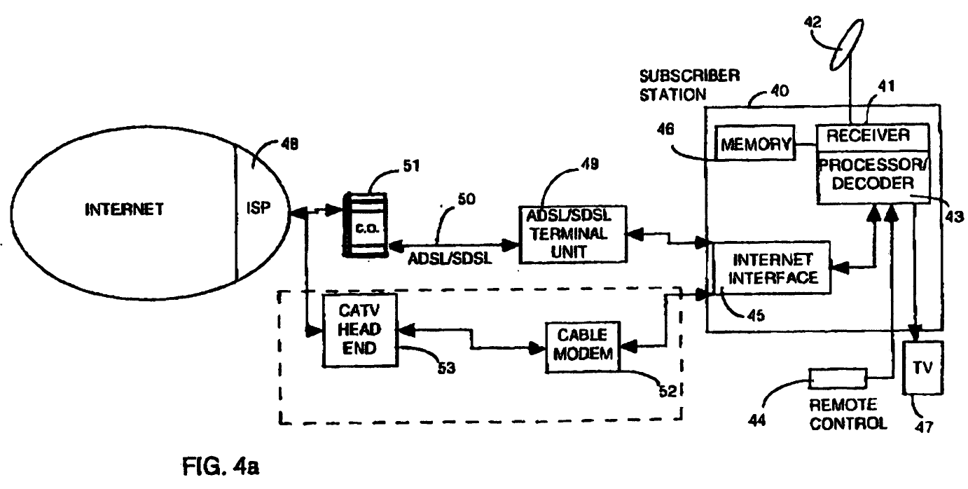

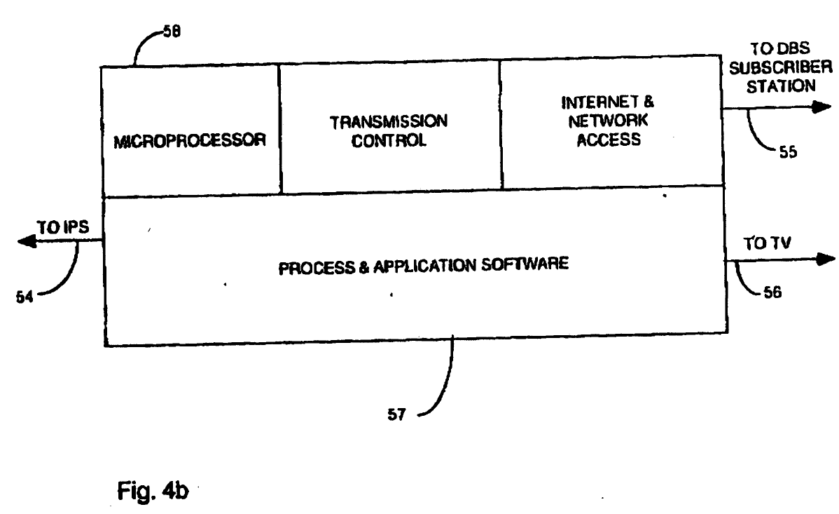

Referring now to FIG. 4a, we have shown a block diagram illustrating how a DBS subscriber station is connected to the Internet for providing an interactive return channel with a DBS service provider. As indicated previously, a subscriber station 40 is provided with a small-size dish 42 to capture a broadcast signal transmitted by a geostationary satellite. A processor and decoder 43 enables the decoding of the signal from receiver 41, processes date from remote control 44, and runs software to communicate through the Internet interface 45, and with receiver 41. A memory 46 is used to store the decoding algorithm, software and subscriber-related information, including subscriber usage statistics. The decoded DBS signal can be viewed on the subscriber's television 47.

Access to the DBS subscriber Station 40 is accomplished by means of interface 45 which is provided with a communication link to an Internet service provider 48. One implementation of the interface 45 may be a standard Ethernet connection to the communications link terminating unit. Another implementation may incorporate the communications link terminating unit into the subscriber station, in which case no user-accessible interface may exist. In one illustrated embodiment of the invention, the communication link in provided by means of Asymmetrical Digital Subscriber Line/Symmetrical Digital Subscriber Line (ADSL/SDSL) Terminal Unit 49 providing an ADSL/SDSL link 50 to a telephone central office 51 and from there on to the ISP 48. In another illustrated embodiment at the invention, the communication link is comprised of a cable modem 52 connected to a cable television headend 53 which then provides a connection directly to the Internet service provider 48.

ADSL and SDSL technologies are usable on most telephone lines to provide a separate full-time date path that is piggybacked over the line without affecting telephone service. At the central office 51, the data path will be connected to an Internet service provider to 48 at has connectivity to the global Internet. It should be noted that this technology may also be applied with the data path connected to a private data network or a switched video system rather than to an Internet provider.

Cable modems such as shown at reference numberal 52, can be used with cable television system to provide data connections between the customer's premises and the cable television headend. The cable television systems use coaxial cable drops to the home and a stared coaxial cable or hybrid fibre-coaxial cable infrastructure. The data connectivity is piggybacked on unused spectrum within the bandwidth of the cable. At the headend 53 the data path is connected to an Internet service provider 48 that has connectivity to the global Internet. It should be noted that this technology may also be applied with the data path connected to a private data network rather than an Internet provider.

Referring now to FIG. 4b, we have shown a diagram illustrating the main components of the Internet interface shown in FIG. 4a. At the customer premises, the data signal 54 from the telephone line, cable television system or other interface providing full-time Internet connectivity is linked with one or more devices that can run Internet applications. The connection may be to one or more devices such as a DBS receiver 55, an associated set-top box, a PC and/or to the television 56, depending on where the Internet applications capabilities are implemented.

Whichever method of access is used, the Internet interface's fundamental characteristic is that it is able to provide IP connectivity in both directions at all times. It may also be possible to simulate full-tine connectivity with protocols for rapid set-up of an ISDN 8 channel initiated by an IP application, but this presupposes the channel cannot be pre-empted for other purposes such as voice calls. The cost implications of having separate end-to-end switched circuits set-up between each customer and the DBS provider suggest that simulating full-time IP connectivity in this way is not likely to be an economic solution.

The specific application processes used for the DBS server and client to interact are known to those knowledgeable in this art and need not be described. The process and application software 57, under control of microprocessor 58 would make use of the Internet TCP/IP protocols and Internet processes such as Telnet or File Transfer Protocol (ITP),to interface the subscriber station 40 and ISP 48.

When a subscriber interacts with the DBS in such a way as to require sending a message to the PBS service provider, or when the service provider requires data to he returned from the subscriber, the DBS set-top box utilizes the local Internet connection provided by an Internet service provider as is currently done today for Internet communication.

The subscriber's set-top box contains an implementation of the client part of the DBS services application program, the TCP/IP protocols used by the Internet, as well as the network access protocols. The DBS application program is a program developed to specifically implement the functions or applications that the DBS service provider wishes to have available to the subscriber, e.g. pay-per-view service. The server part of the application would reside at the DBS server location.

The application program may make use of application processes, such as Telnet for remote terminal emulation, or FTP for file transfer if, say, a file of usage data was to be returned to the DBS service provider.

The application program interfaces with the TCP and/or UDP protocols, usually via an Application Programming Interface (AFT). The TCP and UDP protocols provide a means whereby two processes can carry on a dialogue. Logical connections, called sessions, are handled by the TCP and provide reliable (error free, and in sequence) message interchange service between user and application processes.

The TCP interfaces to the IP which provides network routing functions. The network access layer then provides the service required by the specific network that is used.

The DBS service provide is connected to the Internet in a similar manner. The Internet itself routes and delivers messages from the subscriber's Internet service provider using normal Internet addressing and routing methods. Connections can be initiated from the DBS server or from the subscriber. In effect, the subscriber station could be accessed by the service provider in a way similar to accessing a site on the world-wide web. That in, each subscriber would have a “web” page of usage statistics available for retrieval by the service provider. Obviously, certain security precautions could be taken to ensure that this information is only available to the subscriber service provider.

Audience Metering

There are two major parts to audience ratings measurement. The first is the monitoring of household members individual watching habits, e.g. the program they watch, the response to commercials such as muting or leaving the room, turning the television on and off, muting the sound, etc.

The second part is the timely reporting of the household watching events, e.g. reporting once a month of accumulated data, or the immediate reporting of every event as it happens.

This invention can enable real-time reporting in an economical manner for the first time, and it can also partly tackle the first part of the problem as it can enable reporting of turning on or off of the DBS receiver, what channel is being watched, and if the audio in muted (i.e. any of the functions included in the set-top box).

Data collected by the users set-top boxes can be sent to the DBS service provider's data collection point(s) in real time via the Internet, or a variety of other methods, including an a timed basis, or when a specific amount of data has accumulated in the set top box. In all cases the reporting would be via the Internet an described previously. The design of the network and data collection point(s) would require careful consideration of peak traffic handling requirements, and the data reporting method would be a factor in this design.

DBS Security

The first part of this invention provides an interactive real-time communication channel between the DBS service provider and the DBS subscribers. This communications channel enables moving away from the delivery of decryption keys over the broadcast satellite that are used in the set-top box or smart cards, which are prone to attack.

The existing DBS encryption methods are a form of private key encryption.

The lack of a two-way communications channel between the server and the subscriber meant that public key encryption was not possible. This invention provides a duplex communications channel and enables the use of public key encryption techniques, which are better suited to non-secure networks such as DBS.

Security methods such as Kerberos, disclosed in a paper entitled “An Authentication Service for Computer Networks” by B. Clifford Neuman and Theodore Ts'o, IEEE Communications Magazine, Sep. 1994, are now possible with this invention. Karberos, and other public key techniques are able to provide authentication, data integrity, data confidentiality, and authorisation.

With this invention it is now possible to readily change the set-top box decryption algorithm, and to change keys based an communication over the Internet. Novel techniques such as the use of speech recognition (voiceprints) and use of electronic fingerprints in place of PIN numbers become possible.

This invention is not specific to a particular security technique. It enables the use of security procedures which are dependent on an interactive real time communications channel, such as what is provided by the combination of the Internet with DBS.

An example of a public key encryption technique is that used by Netscape Communications Corporation for Internet security. This technique involves the use of RSA public key cryptography. This document covers the use or RSA public key cryptography in a very readable and readily understood manner.

The use of the Internet for DBS real-time duplex communications enables many service other than the audience measurement and security services.

Additional services which are enable by this invention include, but are not limited to:-
subscription updates and changes,
DBS Trouble reports,
Service calls,
Home shopping,
Internet gateway,
Connection to Internet multi-media services.

The availability of an Internet connection between the subscribers and the DBS service provider permits the monitoring of user activity not previously possible.

Every DBS subscriber can be monitored, and the DBS service provider has the option to select or limit which subscribers are monitored. Specifically this invention will permit monitoring and reporting of what every DBS subscriber does with his receiver, including;- usage status (i.e. receiver turned on or off); the specific channel being watched, which combined with a database of schedule information will permit program popularity statistics; monitoring of response to specific commercials, and hence monitoring their effectiveness; monitoring when subscribers switch channels, which can be coordinated with timing of specific commercials or other events.

The statistics that will be obtainable will be of practical value to content providers in ensuring that they have and can hold the required audience, and hence substantiate audience numbers on which pricing of advertising time is based.

Statistics can be obtained by designing the application program, referred to previously, to monitor the desired subscriber activities, compile individual messages which are communicated back to the DBS service provider in real tins, or compile local databases within the set-top box which can be transferred over the Internet to the DBS service provider, by using FTP, for example. The result of implementing this invention changes the television advertising environment. It enables focusing advertisers on small specific targets, which is what advertisers want, and it allows pricing of advertising based on the number of responses to an advertisement, instead of on the number of viewers, since the responses to advertisements are interactive.

1. A method of providing an interactive communication channel over the internet between a provider of direct broadcast services (DBS) and DBS subscribers, comprising:
connecting a DBS subscriber station to a first Internet interface having a first Internet protocol (IP) address;
connecting a DBS server to a second Internet interface having a second Internet protocol address;
providing a communication path between said first Internet interface and a first Internet service provider (ISP) and between said DBS server and a second ISP; and
establishing a communication link between said DBS server and said DBS subscriber station via said first and second ISP over the Internet network to enable the interactive exchange and retrieval of information between said DBS provider and said DBS subscriber station.

2. A method as defined in claim 1, wherein said communication path is established between said DBS subscriber station and DBS provider by requesting said second Internet interface to dial the IP address of said first Internet interface.

3. A method as defined in claim 1, wherein said communication path provides a full-time connection between said first Internet interface and said first ISP.

4. A method as defined in claim 3, wherein a full-time connection is provided between said first Internet interface and said first ISP using an asymmetrical or symmetrical digital subscriber line.

5. A method as defined in claim 3, wherein a full-time connection is provided between said first Internet interface and said first ISP using a cable mode.

6. A method as defined in claim 2, further comprising the step of querying said first Internet interface to retrieve from said DBS subscriber station, audience rating measurements indicative of the DBS subscriber's watching habits.

7. A method as defined in claim 3, further comprising the step of continuously monitoring said DBS subscriber station to measure said DBS subscribers watching habits.

8. A method as defined in claim 3, further comprising the step of transmitting a public encryption key from said DBS server to said DBS subscriber station to update a DBS signal decoding algorithm stored at said DBS subscriber station.

9. A method as defined in claim 8, wherein said public encryption key makes use of Karberos encryption algorithm.

10. A system for providing an interactive communication channel over the Internet between a provider of direct broadcast services (DBS) and DBS subscribers, comprising:
a DBS subscriber station for receiving and decoding DBS signals;
first Internet interface means for connecting said DBS subscriber station to an Internet network, said first Internet interface means having a first Internet protocol (IP) address;
second Internet interface means for connecting a DBS provider's server to said Internet network, said second Internet interface means having a second Internet protocol (IP) address; and
communication link means between said first Internet interface means and said Internet network, to enable the interactive exchange and retrieval of information between said DBS server and said DBS subscriber station via said Internet network.

11. A system as defined in claim 10, wherein a communication path between said first and second interface means is established when said DBS server dials said first IP address.

12. A system as defined in claim 10, wherein said communication link means provides a full-time connection between said DBS subscriber station and said Internet network.

13. A system as defined in claim 12, wherein said communication link means comprises an asymmetrical or symmetrical digital subscriber line.

14. A system as defined in claim 12, wherein said communication link means comprises a cable modem.

15. A system as defined in claim 11, wherein said DBS subscriber station is provided with means for measuring and storing information on said DBS subscriber's watching habits.

16. A system as defined in claim 15, wherein said DBS provider's server continuously monitors said means for measuring and storing via said communication link means.

17. A system as defined in claim 13, wherein said DBS provider's server can retrieve information on said subscriber's watching habits by querying said means for measuring and storing.

18. A system as defined in claim 17, wherein said means for measuring and storing is queried via said communication link means in response to a query command sent to said first Internet interface means.

19. A system as defined in claim 12, wherein said DBS subscriber station is further comprised of means for storing a DBS signal decoding algorithm.

20. A system as defined in claim 19, wherein said DBS signal decoding algorithm makes use of a public key which is continuously updated via said communication link means by said DBS server.

21. A system as defined in claim 20, wherein said DBS decoding algorithm makes use of a Kerberos encryption algorithm.
